(19) United States
(12) Patent Application Publication
(10) Pub. No.: US 2013/0008873 A1
(43) Pub. Date: Jan. 10, 2013

(54) ELECTRICAL HIGH-VOLTAGE ON-LOAD DISCONNECTOR AND METHOD FOR OPENING THE SAME

(75) Inventors: Christoph SIEGENTHALER, Zurich (CH); Markus Keller, Zurich (CH); Michael Boesch, Lichtensteig (CH); Urs Kruesi, Wiesendangen (CH); René Kallweit, Schaffhausen (CH)

(73) Assignee: ABB TECHNOLOGY AG, Zurich (CH)

(21) Appl. No.: 13/542,517

(22) Filed: Jul. 5, 2012

(30) Foreign Application Priority Data
Jul. 4, 2011 (EP) 11172528.9

(51) Int. Cl. H01H 1/06; H01H 1/12

(52) U.S. Cl. 218/146; 218/154

(57) ABSTRACT

A high-voltage disconnector includes first and second contact elements movable along a disconnecting axis with first and second latching elements fixed thereto, respectively, a drive system for moving the first contact element in an opening direction along the axis to open the disconnector, and a restoring system for restoring the second contact element counter to the opening direction. With the disconnector closed, the first and second latching elements are arranged in a latched connection with one another. During an initial phase of the movement of the first contact element in the opening direction the latched connection initially remains, and the second contact element is carried along by the first contact element in the opening direction. During a disconnecting phase, the latched connection is released, the second element is restored by the restoring system counter to the opening direction, and the second contact element is disconnected from the first contact element.

### RELATED APPLICATION

This application claims priority under 35 U.S.C. §119 to European Patent Application No. 11172528.9 filed in Europe on Jul. 4, 2011, the entire content of which is hereby incorporated by reference in its entirety.

### FIELD

The present disclosure relates to the field of high-voltage gas-insulated switchgear assemblies (GIS). More particularly, the present disclosure relates to an on-load disconnector including a movable first contact element and a movable second contact element.

### BACKGROUND INFORMATION

High-voltage switchgear assemblies are understood to be switchgear assemblies configured for rated voltages of 1 kV or higher, for example, of 75 kV or higher.

In the case of on-load disconnectors, a distinction is made between two types, so-called “bus-charging” disconnectors and so-called “bus-transfer” disconnectors. While the interruption of capacitive currents is of primary importance in the case of the “bus-charging” disconnector, the “bus-transfer” disconnector is directed to disconnection situations which occur in switching cases in which a change from a first busbar to a second busbar in rated operation is intended to be carried out. Disconnectors, such as on-load disconnectors, are used both in the case of “bus-transfer” switching actions and in the case of “bus-charging” switching actions.

If, for example, in the case of gas-insulated (GIS) switchgear assemblies including a double busbar, the busbar is changed, then in nominal operation (rated operation) induced voltages and compensating currents occur, which require a certain breaking capacity of the (on-load) disconnector. In rated operation, non-negligible compensating currents occur for a given rated voltage, and a given rated current owing to a so-called coupler bay upon the opening of the on-load disconnector solely on account of the impedances of the current loop formed between the two busbars.

Upon the opening of the (on-load) disconnector, an arc arises between the movable contact and the stationary contact. Depending on the switching case, moreover, temporary overvoltages (VFTs) having a very high frequency (of the order of magnitude of MHz) arise, which can be harmful to the connected devices of the switchgear assembly. The faster an on-load disconnector operates, the fewer arc ignitions occur. Therefore, a movable arc contact that can be moved at high speed is striven for, in order to make contact with, and disconnect from, a stationary arc contact. The movable arc contact is occasionally also called a transient current contact. Directly after the connection of these arc contacts, the continuous current contacts (rated current contacts) of the movable disconnector contact and of the stationary disconnector contact can be brought closer to one another and electrically connected to one another without ignition of arcs and therefore in a manner free of wear.

In the case of an (on-load) disconnector, the respective disconnecting switches used for disconnection and connection of the busbars, depending on the requirements made of the switchgear assembly, have to be able to switch repeatedly in a reliable manner and in a manner free of wear even in the presence of the induced voltages and compensating currents. In the case of gas-insulated switchgear assemblies, the induced voltages are normally not greater than 20 volts. In this case, the currents are estimated at a maximum of 80% of the rated current. In particular cases in which the busbars or the switchgear bays are at greater distances from one another and/or depending on the design and number of the coupler bays, the current loops—and correspondingly also the induced voltages—can become greater than generally usual for (on-load) disconnecting switches. For example, in the case of gas-insulated switchgear bays combined with an outdoor assembly, this induced voltage in rated operation can rise to as much as 300 V, for example, depending on the switchgear assembly. Therefore, there is a need for an (on-load) disconnecting switch which switches reliably and in a manner free of wear even under increased requirements.

For this purpose, high-voltage (on-load) disconnectors having a fixed contact and a disconnector tube as movable contact exist, for instance. In the case of these disconnecting switches, a follow-on contact is integrated in the fixed contact, which is able to support an arc. Upon the opening of the switch, an arc can form between the disconnector tube and the follow-on contact. By virtue of the fact that such disconnectors are designed for supporting an arc, they are able to disconnect under a certain load, for example at a voltage of 20 V and a current of 1600 A. Such disconnectors are entirely sufficient for many situations. However, situations also occur in which rapid, reliable and low-wear disconnection is desired even under higher load.

DE 600 30 032 T2 discloses a gas-insulated high-voltage disconnecting switch including a rapidly movable contact. The disconnecting switch has a fixed contact and a movable contact. A piston is situated within the movable contact, the piston being actuated by an actuating rod. Two springs are arranged between respective ends of the movable contact and the piston. Furthermore, two locking systems are provided in order to fix the movable contact in an axial direction relative to the piston. As a result, the movable contact can be displaced independently of the actuating rod and the piston.

EP0348645A2 discloses a gas-insulated switchgear assembly including a contact that can be moved into a mating contact. Arc-throughs of small currents when disconnecting switches are switched on and switched off can be avoided, in accordance with EP0348645A2, by virtue of the fact that a quick-acting clamping spring prestressed by springs provides for accelerated contact-making or interruption.

### SUMMARY

An exemplary embodiment of the present disclosure provides an electrical high-voltage disconnector. The exemplary disconnector includes a first contact element movable along a disconnecting axis with a first latching element fixed to the first contact element, and a second contact element movable along the disconnecting axis with a second latching element fixed to the second contact element. The exemplary disconnector also includes a drive system configured for moving the first contact element in an opening direction along the disconnecting axis relative toward the second contact element to open the disconnector, and a restoring system configured for restoring the second contact element counter to the opening direction. With the disconnector closed, the first latching element and the second latching element are configured to be latched into one another and form a latched connection. Upon the opening of the disconnector in a first position region of the first contact element relative to the disconnecting axis, an adhesion force of the latched connection is high such that the second contact element is carried along by the first contact element upon the movement of the first contact element in the opening direction. Upon the opening of the disconnector, the adhesion force of the latched connection in a second position region of the first contact element, the second position region being adjacent to the first position region relative to the disconnecting axis, is releasable, such that the second contact element is restored by the restoring system counter to the opening direction and the second contact element is disconnected from the first contact element.

An exemplary embodiment of the present disclosure provides a method for opening an electrical high-voltage disconnector. The exemplary high-voltage disconnector includes: a first contact element with a first latching element fixed thereto; a drive system for moving the first movable contact element in an opening direction along the disconnecting axis relative toward the second contact element to open the disconnector; a second contact element with a second latching element fixed thereto; and a restoring system configured for restoring the second contact element counter to the opening direction. The exemplary method includes closing the disconnector such that the first latching element and the second latching element are latched into one another and form a latched connection; moving the first contact element in the opening direction along a disconnecting axis through a first position region of the first contact element relative to the disconnecting axis; maintaining an adhesion force of the latched connection upon the movement of the first contact element in the opening direction through the first position region, such that the second contact element is carried along by the first contact element upon the movement of the first contact element in the opening direction; releasing the holding force in a second position region of the first contact element, the second position region being adjacent to the first position region relative to the disconnecting axis; restoring the second contact element by the restoring system counter to the opening direction, such that the second contact element is disconnected from the first contact element.

### BRIEF DESCRIPTION OF THE DRAWINGS

Additional refinements, advantages and features of the present disclosure are described in more detail below with reference to exemplary embodiments illustrated in the drawings, in which:

FIG. 1 show a high-voltage disconnector in accordance with an exemplary embodiment of the present disclosure in an open state;

FIG. 2a shows the high-voltage disconnector from FIG. 1 in a closed state, in accordance with an exemplary embodiment of the present disclosure;

FIG. 2b shows the high-voltage disconnector from FIG. 1 during an initial phase of disconnection at the end of a first position region of the first contact element relative to the disconnecting axis, in accordance with an exemplary embodiment of the present disclosure;

FIG. 2c shows the high-voltage disconnector from FIG. 1 during a disconnecting phase of disconnection in a second position region of the first contact element relative to the disconnecting axis, in accordance with an exemplary embodiment of the present disclosure;

FIG. 3 shows a high-voltage disconnector in accordance with an exemplary embodiment of the present disclosure during an initial phase of disconnection;

FIGS. 4a and 4b show a first and second movable contact element, respectively, of a high-voltage disconnector in accordance with an exemplary embodiment of the present disclosure; and

FIG. 5 shows an enlarged view of a high-voltage disconnector in accordance with an exemplary embodiment of the present disclosure, in which the first and second movable contact elements are visible.

### DETAILED DESCRIPTION

An exemplary embodiment of the disclosure provides an electrical high-voltage disconnector which includes a first contact element movable along a disconnecting axis with a first latching element fixed thereto, a second contact element movable along the disconnecting axis with a second latching element fixed thereto, a drive system for moving the first contact element in an opening direction along the disconnecting axis in order to open the disconnector, and a restoring system for restoring the second contact element counter to the opening direction. The first and second latching elements are arranged in such a way that the following configuration results.

With the disconnector closed, the first latching element and the second latching element are latched into one another and form a latched connection. During an initial phase of the movement of the first contact element in the opening direction, the latched connection initially remains in a first position region of the first contact element relative to the disconnecting axis, such that the second contact element is carried along by the first contact element in the opening direction. In other words, upon the opening of the disconnector, an adhesion force of the latched connection in a first position region of the first contact element relative to the disconnecting axis is so high, that is to say so maintainable, that the second contact element is/can be carried along by the first contact element upon the movement of the first contact element in the opening direction. Depending on the embodiment of the disconnector, the adhesion force during the operation of the disconnector can be applied, for example, magnetically or by means of a suitable geometry (geometrically) or else by both magnetic and geometrical means in combination.

Afterward, the latched connection is released during a disconnecting phase of the movement, such that the second contact element is restored by the restoring system counter to the opening direction, and the second contact element is disconnected from the first contact element in a second position region of the first contact element relative to the disconnecting axis. Hereinafter, the term “latching” is not interpreted narrowly by latching requiring a mechanical latching device including releasable latching elements that latch into one another and are correspondingly embodied in a positively locking manner. Rather, the term “latching” in the present disclosure is intended to be understood to the effect that the movable first contact element assumes a predefined position relative to its mating contact element in the direction of the disconnecting axis and requires that a certain resistance value be overcome in order to extract the movable first contact element again from the “latched state”—that is to say the “latching position” assumed. As a representative of such non-mechanical alternatives, mention should be made at this juncture of, for example, a magnetic connection, the attractive forces of which likewise form a force-locking latching connection within the meaning of the present disclosure for generating the adhesion force mentioned. In other words, upon the opening of the disconnector in the operating state thereof, the adhesion force of the latched connection in a second position region of the first contact element, the second position region being adjacent to the first position region, relative to the disconnecting axis is releasable, that is to say reproducible in terms of forces, such that the second contact element is/can be restored by the restoring system counter to the opening direction, and the second contact element is/can be disconnected from the first contact element.

The disconnector can be, for example, an on-load disconnector.

An exemplary embodiment of the present disclosure also provides a method for opening an electrical high-voltage disconnector in the operating state thereof. The high-voltage disconnector includes a first contact element with a first latching element fixed thereto, a drive system for moving the first movable contact element in an opening direction along the disconnecting axis relative toward the second contact element to open the disconnector, a second contact element with a second latching element fixed thereto, and a restoring system for restoring the second contact element counter to the opening direction. In the method, the disconnector is firstly closed, such that the first latching element and the second latching element are latched into one another and form a latched connection. The exemplary method includes the following processes or method steps: (i) moving the first contact element in the opening direction along a disconnecting axis through a first position region of the first contact element relative to the disconnecting axis; (ii) maintaining an adhesion force of the latched connection upon the movement of the first contact element in the opening direction through the first position region, such that the second contact element is carried along by the first contact element upon the movement of the first contact element in the opening direction; (iii) releasing the holding force in a second position region of the first contact element, where the second position region is adjacent to the first position region relative to the disconnecting axis; and (iv) restoring the second contact element by the restoring system counter to the opening direction, such that the second contact element is disconnected from the first contact element.

An advantage of the disconnector according to the present disclosure is that upon the disconnection of the arc contacts, a high relative speed between the contact elements can be rapidly achieved. Rapid extinguishing of the arc that forms is thereby fostered. As a result, with the disconnector according to the present disclosure, even relatively high loads in rated operation, for example powers of 480 kW, can be repeatedly switched rapidly, reliably and with little wear.

The disconnector according to the present disclosure differs fundamentally from the disconnector described in DE 600 30 032 T2 since, in the disconnector described therein, only a locking system between parts of a movable contact is described, and the fixed contact has no locking system whatsoever. By contrast, the latching elements of the disconnector according to the present disclosure permit a latched connection between contact pieces situated on different sides of the disconnecting section with the disconnector open. During the opening process of the disconnector, one of the contact pieces is firstly carried along by the other on account of the latched connection, and then the contact pieces are disconnected from one another and moved apart as a result of the connection being released. A particularly high relative acceleration and speed of the two contact pieces can be achieved as a result. Furthermore, in accordance with exemplary embodiments of the present disclosure, the contact elements are offset radially relative to one another and make contact with one another in a substantially radial direction, for example, in a radial rather than in an axial direction, with respect to an axis of the disconnector.

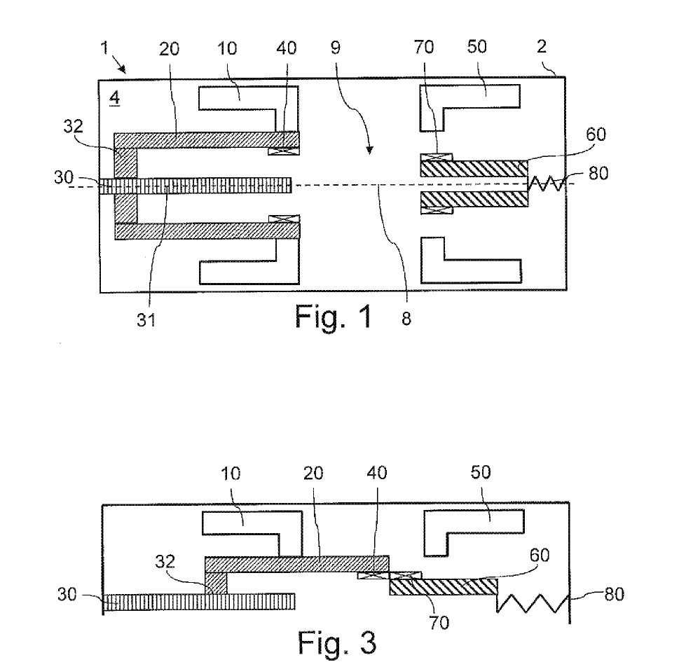

FIG. 1 shows a high-voltage disconnector 1, more precisely a high-voltage on-load disconnector, in accordance with an exemplary embodiment of the present disclosure. The disconnector 1 has a housing 2, which defines an internal volume 4. The housing 2 can be gas-tight in order to hold an insulating gas or a vacuum or a low pressure. Furthermore, the disconnector 1 includes a first fixed contact 10 (also designated as first stationary contact piece 10), a disconnector tube 20, also designated hereinafter as movable first contact element 20, a drive system or a drive mechanism 30 for the disconnector tube 20 for moving the disconnector tube 20 in an opening direction 7 along the disconnecting axis relative toward a second contact element 60, described in even greater detail below, in order to open the disconnector, and a first latching element 40. These elements form a first side of the disconnector. Furthermore, the disconnector 1 includes a second fixed contact 50 (also designated as secondary stationary contact piece 50), the abovementioned second contact element 60 embodied in a movable fashion, a latching element 70, and a restoring system 80. These elements form a second side of the disconnector, which is separated from the first side of the disconnector by a disconnecting section 9. The disconnector has an axis 8 of the disconnector.

The first fixed contact 10 is arranged in a stationary fashion relative to the disconnector housing 2. The movable first contact element 20 is electrically connected to the first fixed contact 10, for example, via a sliding contact. This connection exists independently of the movement state of the movable first contact element 20. The first latching element 40 is fixed at a distal end (e.g., an end arranged in an axial direction toward the isolating section or toward the other, e.g., second, contact element) of the movable first contact element 20. The first contact element 20 and/or the first fixed contact 10 is/are arranged substantially rotationally symmetrically or predominantly rotationally symmetrically about the axis 8 of the disconnector. The first contact element 20 and/or the first fixed contact 10 can have, for example, a cylinder-like section.

The movable first contact element 20 is movable along a disconnecting axis corresponding to the axis 8 of the disconnector. In order to guide this movement, the movable second contact element 60 is mounted by a guide system, for example, a rail running along the disconnecting axis or a guide pin. In order to drive the movement of the movable first contact element 20, the drive mechanism 30 has a spindle 31, which extends along the axis 8 of the disconnector and is rotatable about the latter. A motor and/or a hand crank may be provided for rotating the spindle 31. A driver fixed to the movable first contact element 20 cooperates with the spindle 31 in such a way that a rotation of the spindle 31 about the axis 8 of the disconnector is converted into a longitudinal movement of the movable first contact element 20 along the axis 8 of the disconnector.

The second fixed contact 50 is likewise arranged in a stationary fashion relative to the disconnector housing 2. The movable second contact element 60 is movable along a disconnecting axis corresponding to the axis 8 of the disconnector. In order to guide this movement, the movable second contact element 60 is mounted by a guide system, for example, a rail running along the disconnecting axis or a guide pin. The restoring system 80 is formed by a restoring spring connected to the housing 2 at one end of the spring and to the movable second contact element 60 at the end other of the spring. As a result, the restoring spring 80 is able to pull the movable second contact element 60 away from the first fixed contact 10. The restoring spring 80 is, for example, a helical spring arranged coaxially around a shaft rigidly connected to a housing of the disconnector. In accordance with an exemplary embodiment of the present disclosure, the restoring spring 80 can be the sole spring acting on a contact element within the housing 2. Furthermore, a damping element is arranged within an internal volume of the housing 2 in order to damp the restoring movement with respect to the restoring spring 80. For example, the damping element is arranged for damping the restoring movement of the second contact element 60 counter to the opening direction 7. The damping element can be oil-free in order to reduce contamination of the interior of the housing 2, and include, for example, an annular spring. Furthermore, a stop is provided, which delimits the movement of the movable second contact element 60 counter to the opening direction. Further stops can also delimit further movement of the movable first and/or second contact element 20, 60.

The movable second contact element 60 is electrically connected to the second fixed contact 50, for example, via a sliding contact. The second latching element 70 is fixed at a distal end (e.g., an end arranged in an axial direction toward the isolating section or toward the other, e.g., first, contact element) of the movable second contact element 60. The second contact element 60 and/or the second fixed contact 50 may be arranged substantially rotationally symmetrically about the axis 8 of the disconnector. The second contact element 60 and/or the second fixed contact 50 can have, for example, a cylinder-like section. The second contact element 60 can also be embodied as a contact tulip.

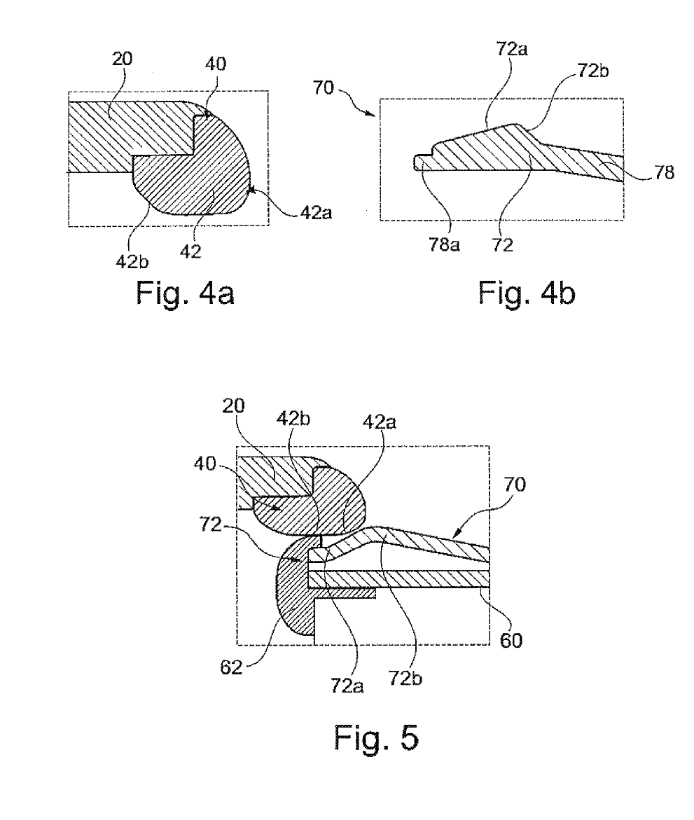

The first latching element 40 and the second latching element 70 are designed such that they latch into one another when they come close to one another. In the latched state, the latching elements 40 and 70 are mechanically connected to one another. This latched state is releasable again. In accordance with an exemplary embodiment of the present disclosure, the latched state is released if the latching elements 40 and 70 are pulled apart with a relative force exceeding a limit value in the direction of the disconnecting axis, and so this exceeds an adhesion force (adhesion effect) of the latched connection. This property of the latching elements 40 and 70 can be realized by mechanical snap action, for example, as is explained in greater detail further below with reference to FIGS. 4a to 5. Alternatively, magnetic latching elements can also be provided. In accordance with an exemplary embodiment of the present disclosure, therefore, the first and second latching elements 40 and 70 each include a magnet.

In accordance with an exemplary embodiment of the present disclosure, the latched state is released by external action. By way of example, the latched connection can be effected by an electromagnet that can optionally be switched on and off. In accordance with this exemplary embodiment, the latched connection is released by the electromagnet being switched off, such that the adhesion force between the first and second latching elements 40 and 70 is cancelled and the latched connection 40, 70 is released. The latched connection can also be effected by a bolt that is fitted to one of the two movable contact elements and can be moved into and out of a hole in the other of the movable contact elements. In accordance with this exemplary embodiment, the latched connection is released by the bolt being moved out of the hole.

In accordance with an exemplary embodiment of the present disclosure, the first contact element 20 and the second contact element 60 are electrically connected to one another with the disconnector closed, and the first contact element 20 and the second contact element 60 are electrically isolated from one another with the disconnector open.

The disconnector can optionally be opened or closed by means of the longitudinal movement of the movable first contact element 20. FIG. 1 illustrates the disconnector in an open state. Here, the movable first contact element 20 is moved toward the left. This direction toward the left is therefore also designated as the opening direction in this example. As a result, the element is electrically connected to the first fixed contact 10, but disconnected from the second fixed contact 50 by the disconnecting section 9.

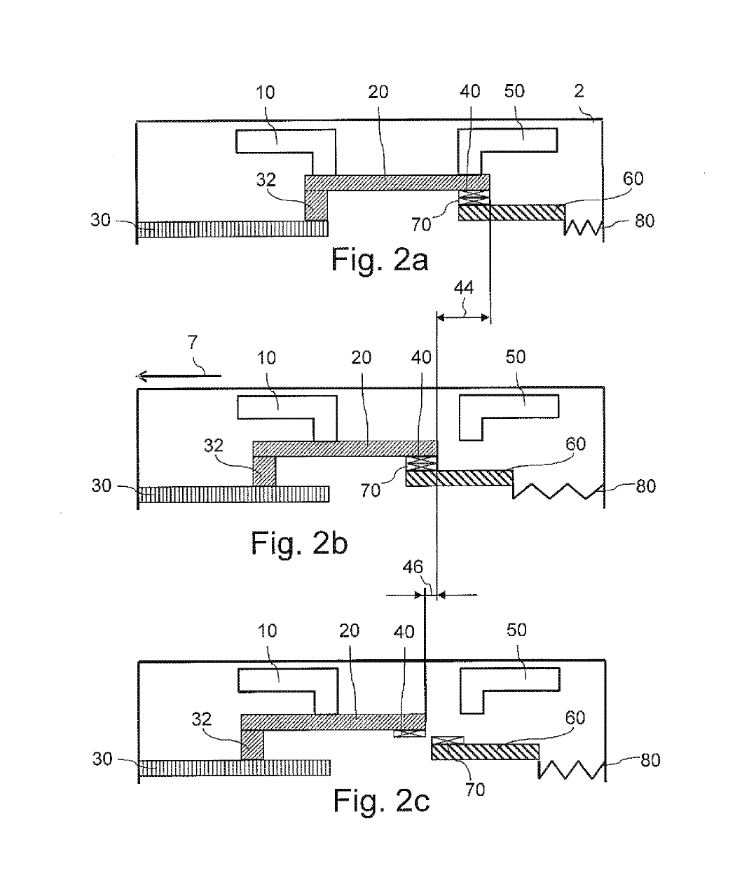

FIG. 2a illustrates the disconnector in a closed state according to an exemplary embodiment of the present disclosure. Here, the movable first contact element 20 is moved toward the right (e.g., counter (opposite) to the opening direction), such that the movable first contact element 20 makes contact with the second fixed contact 50. As a result, the contact element is electrically connected not only to the first fixed contact 10 but also to the second fixed contact 50, and therefore establishes an electrical connection bridging the disconnecting section 9 between the first and second sides of the disconnector, the electrical connection closing the disconnector. In accordance with an exemplary embodiment of the present disclosure, the movable first contact element 20 can be moved counter to the opening direction in such a way that it becomes electrically connected to the second fixed contact 50 (e.g. via a sliding contact).

Overall, therefore, the first and second contact elements 20 and 60, and thus also the first and second fixed contacts 10 and 50, are electrically connected to one another with the disconnector closed, and are disconnected from one another by the disconnecting section 9 with the disconnector open. With the disconnector closed, the second fixed contact 50 carries a main portion of the current flowing through the disconnector. By contrast, the movable second contact element 60 carries only a lower or even a negligible current.

As can furthermore be seen in FIG. 2a, in the closed switching state, the first latching element 40 is moved into the vicinity of the second latching element 70 in such a way that the two latching elements 40, 70 are latched into one another and form a latched connection. This means that upon a movement of the first latching element 40 (jointly with the first movable contact element) the second latching element 70 (and thus also the second movable contact element 50) is carried along because the first latching element 40 and the second latching element 70 adhere to one another.

For the purpose of opening the disconnector, the first contact element 20 is moved in the opening direction, toward the first stationary contact piece 10. The opening direction is illustrated by arrow 7 in FIG. 2b. FIG. 2b illustrates the disconnector during an initial phase of the movement of the first contact element 20 in the opening direction 7. The latched connection between the first latching element 40 and the second latching element 70 initially remains in a first position region 44 of the first contact element 20 relative to the disconnecting axis, such that the movable second contact element 60 is carried along by the movable first contact element 20 in the opening direction 7. In this case, the term “first position region 44” is understood to mean a position region which extends in the direction of the axis 8 of the disconnector and which is delimited in the direction of the restoring spring 80 by the position of the first latching element 40 and the second latching element 70 in the closed position of the disconnector. In the direction of the stationary contact piece 10, the first position region is delimited by a second position region 46 adjoining it.

As a result of the movement of the movable first contact element 20, the connection thereof to the second fixed contact 50 is interrupted, while the connection thereof to the movable second contact element 60 still remains on account of the latched connection of the latching elements 40 and 70. Upon the disconnection of the connection between the movable first contact element 20 and the second fixed contact 50, the current previously carried by the fixed contact 50 is commutated to the movable second contact element 60 upon the opening of the disconnector and an arc is thus avoided.

The movable second contact element 60 is moved counter to the force of the restoring spring 80, which pulls the movable second contact element 60 counter to the opening direction 7. In the carrying-along process, a relative force is transmitted, that is to say an adhesion force between the first latching element 40 and the second latching element 70, for example, the force necessary to accelerate the second contact element 60 counter to the force of the restoring spring 80 and counter to its own mass inertia such that the second contact element 60 is carried along. Since the restoring spring 80 is tensioned to an ever greater extent with increasing deflection of the second contact element 60 counter to the opening direction 7, the relative force likewise becomes ever higher.

If the relative force (adhesion force) then exceeds a specific limit value, the latched connection between the first latching element 40 and the second latching element 70 is released. Upon the opening of the disconnector, the adhesion force of the latched connection 40,70 is releasable/reducible in a second position region 46 of the first contact element 20, the second position region being adjacent to the first position region 44, relative to the disconnecting axis. Like the first position region 44, the second position region 46 also extends in the direction of the axis 8 of the disconnector. While the second position region is delimited by the first position region 44 on one side, it is delimited on its opposite side by a relative position by a position of the first latching element 40 and the second latching element 70 in which the previously latched connection thereof is now cancelled/released. A disconnecting phase (illustrated in FIG. 2c) of the movement begins with this release, in which phase the second contact element 60 is restored by the restoring system 80 counter to the opening direction 7 and the second contact element 60 is disconnected from the first contact element 20.

FIG. 2b and FIG. 2c illustrate the first position region 44 and the second position region 46 on the basis of that end face of the first latching element 40 which is directed in the direction of the restoring spring 80.

After the conclusion of the disconnecting phase, the second contact element 60 is restored again into its initial position illustrated in FIG. 1.

During the disconnecting phase illustrated in FIG. 2c, an arc can form between the contact elements 20, 60. For this purpose, the contact elements 20 and/or 60 may be provided with respective erosion sections in order to support an arc that forms between them during and/or after the disconnecting phase. Examples of such erosion sections are the erosion rings illustrated in FIG. 5. Since the movable contact elements 20 and 60 move apart very rapidly during the disconnecting phase, the arc can be extinguished rapidly and reliably, only little erosion of the contacts occurring. It is thereby possible to switch, for example, currents of 1600A at a voltage of 300V. The fact that the disconnector is designed for switching a current of at least 1600A and a voltage of at least 300V constitutes an exemplary embodiment of the present disclosure.

The following general, mutually independent aspects of the present disclosure which are illustrated in the embodiment from FIGS. 1 to 2c contribute to the movable contact elements rapidly moving apart. On both sides of the disconnector, there are movable contact elements which move apart in opposite directions during the disconnecting phase. As a result, a high relative movement can be obtained without the movable contact elements having to take up an excessively large amount of kinetic energy, which increases with the square of the speed. Furthermore, the release of the movable contact elements from one another begins only after the movable first contact element has already been accelerated to a substantial speed (e.g. more than 30% or even more than 50% of the maximum speed). This ensures that the disconnection is effected only when an initial acceleration of the movable first contact element has already been performed. This initial acceleration may proceed in a somewhat retarded fashion on account of adhesion forces, for example, and would therefore delay the extinguishing of the arc. Furthermore, a movement reversal takes place in the case of the movable second contact element. It is thereby possible to obtain a high relative speed between the movable contact elements without the second movable contact element having to take up an excessively large amount of kinetic energy, which increases with the square of the speed. Furthermore, the second movable contact element has a moved mass that is lower than the moved mass of the first movable contact element. As a result, a high acceleration of the second movable contact element can be achieved during the disconnecting phase. Furthermore, the restoring spring is tensioned during the initial phase of the movement, and the restoring spring pulls the second movable contact element counter to the opening direction during the disconnecting phase of the movement. As a result, the restoring spring can store energy coming from the drive system, and subsequently make this energy available in the time period relevant to the extinguishing of the arc within a short time for the acceleration of the second movable contact element.

In the case of the disconnector illustrated in FIGS. 1 to 2c, the first latching element 40 is arranged radially outside the second latching element 70, such that in the latched connection the second latching element 70 bears against the first latching element 40 radially on the outer area, as is illustrated in FIG. 2b. Consequently, the first latching element 40 is directed inward, and the second latching element 70 is directed outward.

FIG. 3 shows an examplaray embodiment, wherein, in the latched connection, the second latching element 70 bears alongside the first latching element 40 in the direction of the axis 8 of the disconnector. Here a latching connection can likewise be established between the latching elements 40, 70, for example, by magnetic or mechanical properties of the latching elements.

FIGS. 4a and 4b show a first movable contact element 20 with a latching element 40 fixed thereto, and a second latching element 70 of a high-voltage disconnector in accordance with an exemplary embodiment of the present disclosure. These latching elements 40 and 70 can be used, for example, in the high-voltage disconnector from FIGS. 1 to 2c.

The latching elements 40 and 70 illustrated in FIGS. 4a and 4b are designed to engage mechanically into one another as follows. The first latching element 40 (see FIG. 4a), has a projection 42 directed radially inward (toward the axis of the disconnector). The projection 42 includes on its side directed toward the opening direction (left-hand side in FIG. 4a) a first proximal surface section 42b, which is inclined toward the opening direction, and on its side directed away from the opening direction (right-hand side in FIG. 4a) a first distal surface section 42a, which is inclined away from the opening direction. The designations “distal” and “proximal” mean here that the distal surface section 42a is arranged closer toward the isolating section or toward the other (second) contact element in an axial direction than the proximal surface section 42b. These two surface sections 42a and 42b laterally delimit an approximately flat central piece of the projection 42. The first latching element 40 and the projection 42 are fixed substantially rigidly to the first movable contact element 20. The surface section 42b is embodied as an erosion section and has an analogous function to the erosion sections as illustrated in FIG. 5.

The second latching element 70 (see FIG. 4b) conversely has a latching head embodied as a projection 72 directed radially outward (away from the axis of the disconnector). The projection 72 includes on its side directed toward the opening direction (left-hand side in FIG. 4b) a second distal surface section 72a, which is inclined toward the opening direction, and on its side directed away from the opening direction (right-hand side in FIG. 4b) a second proximal surface section 72b, which is inclined away from the opening direction. Once again the distal surface section 72a is arranged closer toward the isolating section or toward the other (first) contact element in an axial direction than the proximal surface section 72b. These two surface sections 72a and 72b laterally delimit the projection 72. The projection 72 is mounted on the second movable contact element 60 by means of an elastic element, here a bending spring 78. The second latching element 70 is embodied integrally with the elastic element 78. The second latching element 70 is pressed by the elastic element 78 radially outward, for example, in an engagement direction. In order to release the latched connection, the second latching element 70 can be moved radially inward, for example, counter to the engagement direction.

The second latching element 70 further has an axial projection 78a arranged radially within a stopper piece. The stopper piece is not illustrated in FIG. 4b, but arranged analogously to the stopper piece of the element 62 from FIG. 5. The stopper piece makes available a stop for a radial deflection of the second latching element 70 and defines a maximum deflection of the second latching element 70 radially outward, and thus prevents excursion beyond the maximum deflection.

The first latching element 40 is arranged radially outside the second latching element 70, as is illustrated in FIGS. 1 to 2c. Therefore, the projection 42 of the first latching element 40 protrudes toward the second latching element 70, and the projection 72 of the second latching element 70 protrudes toward the first latching element 40. The latching elements 40 and 70 are arranged such that the projections 42 and 72 overlap in a radial direction.

The latching elements 40 and 70 latch into one another by means of the first latching element 40 being guided counter to the opening direction, for example, toward the right, past the second latching element 70 such that the first latching element 40 presses the second latching element 70 counter to the force of the elastic element 78 in the direction of the axis of the disconnector. Latching is effected in a state in which the second movable contact element bears against and therefore cannot be moved further counter to the opening direction, for example, further toward the right. Since the second distal surface section 72a is inclined toward the opening direction, latching can be effected gently and with little abrasion. For this purpose, it is advantageous —but not absolutely necessary—for the inclinations of the distal surface sections 42a and 72a to correspond to one another.

After latching, the elastic element 72 presses the second latching element again upward (in the engagement direction), such that the proximal surface sections 42b and 72b bear against one another and engage in one another. If the movable first contact element 20 is then moved in the opening direction (toward the left), the movement is transmitted in the first position region 44 via the contact of the proximal surface sections 42b and 72b to the second latching element 70 and thus to the movable second contact element 50.

As has already been described above, the engagement forming the adhesion force, and thus the latching connection, is released if the movable second contact element 50 or the second latching element 70 is pulled counter to the opening direction with a force exceeding a threshold value relative to the first contact element 20 or the first latching element 40, respectively. In this case, as a result of the inclination of the surface sections 42b and 72b, the force presses the second latching element 70 counter to the spring force of the elastic element 78 in the direction of the axis of the disconnector (counter to the engagement direction) until the distal surface section 42a has crossed a vertex formed by the distal surface section 72a and the proximal surface section 72b, such that the latching connection is released and the second latching element 70 is pulled past the first latching element 40 counter to the opening direction away from the first latching element 40.

The inclinations of the proximal surface sections 42b and 72b correspond to one another and are adapted to the spring constant of the elastic element 78 such that the threshold value of the adhesion force is reached when the disconnecting phase is intended to begin in the second position region 46.

The inclination of the second distal surface section 72a is chosen such that an arc is led away as rapidly as possible from the surface section 72a. For this purpose, a shallow inclination (having a small angle relative to the axis of the disconnector) of the surface section 72a is advantageous. According to an exemplary embodiment of the present disclosure, the second distal and the second proximal surface section 72a, 72b have a mutually different inclination. In particular, the inclination of the second distal surface section 72a can be shallower than the inclination of the second proximal surface section 72b.

According to an exemplary embodiment of the present disclosure, the second proximal surface section 72b is arranged at a distance of more than 1 cm in an axial direction from an end of the second latching element 70 that is directed toward the opening direction. This ensures that a length of the second latching element 70 along which the first latching element 40 can slide is still available even after the release of the latching connection. The length allows the second latching element 70 to be accelerated relative to the first latching element 40 before the latching elements 40 and 70 are disconnected, that is to say the first latching element 40 goes away from that end of the second latching element 70 which is directed toward the opening direction. As a result, at the time of disconnection it is possible to achieve a considerable relative speed, which fosters rapid extinguishing of the arc.

FIG. 5 shows an enlarged view of a disconnector in accordance with an exemplary embodiment of the present disclosure. The first and second movable contact elements 20 and 60, and the first and second latching elements 40 and 70, can be seen in FIG. 5. The latching elements 40 and 70 correspond to the elements illustrated in FIGS. 4a and 4b, and the description of FIGS. 4a and 4b also applies to FIG. 5. FIG. 5 illustrates the elements 40 and 70 in the latched state. In contrast to FIG. 4b, in FIG. 5 the elastic element 78 is realized by a leaf spring instead of by a bending spring.

Furthermore, an erosion section 62 of the second contact element is provided in FIG. 5. In accordance with an exemplary embodiment of the present disclosure, such an erosion section 62 is arranged at an axial (distal) end of the second contact piece 60, for example, adjacent to the second latching element 70 in an axial direction. The erosion section can be embodied as a cap, for example, as illustrated in FIG. 5, the cap at least partly covering the second contact piece 60 and/or the second latching element 70 in an axial direction. Furthermore, an erosion section of the first contact element is defined by the surface section 42a. The erosion section 42a is embodied integrally with the first latching element 40. The erosion sections 62 and 42a are arranged to support an arc that forms between them during and/or after the disconnecting phase. The erosion section 62 of the second contact element 60 is arranged adjacent to the second latching element 70, more precisely adjacent to the second distal surface section 72a. The erosion section 62 additionally forms the stopper described above with reference to FIG. 4a.

Analogously to FIGS. 2a-2b, the exemplary embodiment described in FIGS. 4 to 5 also has respectively a first position region 44 and a second position region 46. The first position region 44 is defined in the direction of the restoring element 80 by the position of the first latching element 40 relative to the second latching element 70 with the disconnector closed. In this case, the inclined surface sections 42b and 72b face one another. In the direction of the stationary contact piece 10, the first position region 44 is delimited by a second position region 46 adjoining it. The boundary of the first position region 44 with respect to the second position region 46 is situated where the distal surface section 42a of the first latching element 40 leaves the vertex formed by the distal surface section 72a and the proximal surface section 72b of the second latching element 70, such that the effect of the holding force applied by the elastic element 78 between first latching element 40 and second latching element 70 is cancelled.

The present disclosure has been explained by way of example on the basis of a protective gas disconnector. However, it is also suitable for other disconnectors for high- and medium-voltage applications, in particular of substations, for example, for vacuum interrupters, self-blowing circuit breakers, etc.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An electrical high-voltage disconnector, comprising
a first contact element movable along a disconnecting axis with a first latching element fixed to the first contact element;
a second contact element movable along the disconnecting axis with a second latching element fixed to the second contact element;
a drive system configured for moving the first contact element in an opening direction along the disconnecting axis relative toward the second contact element to open the disconnector; and
a restoring system configured for restoring the second contact element counter to the opening direction, wherein:
with the disconnector closed, the first latching element and the second latching element are configured to be latched into one another and form a latched connection;
upon the opening of the disconnector in a first position region of the first contact element relative to the disconnecting axis, an adhesion force of the latched connection is high such that the second contact element is carried along by the first contact element upon the movement of the first contact element in the opening direction, and
upon the opening of the disconnector, the adhesion force of the latched connection in a second position region of the first contact element, the second position region being adjacent to the first position region relative to the disconnecting axis, is releasable, such that the second contact element is restored by the restoring system counter to the opening direction and the second contact element is disconnected from the first contact element.

2. The electrical high-voltage disconnector as claimed in claim 1, comprising:
a fixed contact configured for making contact with the first contact element to close the disconnector.

3. The electrical high-voltage disconnector as claimed in claim 1, where the first and second contact elements have respective erosion sections, which are arranged to support an arc which can be formed between them.

4. The electrical high-voltage disconnector as claimed in claim 1, wherein the restoring system comprises a restoring spring.

5. The electrical high-voltage disconnector as claimed in claim 4, wherein, upon the opening of the disconnector, the adhesion force of the latched connection in the second position region of the first contact element relative to the disconnecting axis is releasable due to a force component of the restoring system that acts in the direction of the disconnecting axis exceeds a force component of the adhesion force that acts in the direction of the disconnecting axis.

6. The electrical high-voltage disconnector as claimed in claim 1, comprising:
a gas-tight housing wherein the restoring system has a damping element arranged within an internal volume of the housing.

7. The electrical high-voltage disconnector as claimed in claim 1, wherein the first and second contact elements are arranged substantially rotationally symmetrically about an axis of the disconnector.

8. The electrical high-voltage disconnector as claimed in claim 1, wherein the first and second latching elements are configured to engage mechanically into one another.

9. The electrical high-voltage disconnector as claimed in claim 8, wherein the second latching element has in a latching region a multiplicity of elastic elements which are movable upon latching radially with respect to the disconnecting axis toward the first latching element, the elastic elements being movable for releasing the latched connection counter to a spring force of the elastic elements radially with respect to the disconnecting axis away from the first latching element.

10. The electrical high-voltage disconnector as claimed in claim 9, wherein the second latching element is embodied as clamping tongues in a latching region, wherein the elastic elements are embodied integrally with a body extending circumferentially in a circumferential direction.

11. The electrical high-voltage disconnector as claimed in claim 8, wherein the first latching element is embodied as a projection protruding radially toward the second latching element with respect to an axis of the disconnector and has a first distal surface section, which is inclined away from the opening direction, and a first proximal surface section, which is inclined toward the opening direction,
wherein, with the disconnector open, the first distal surface section is arranged closer toward the second contact element in an axial direction than the first proximal surface section,
wherein the second latching element is embodied as a projection protruding radially toward the first latching element with respect to the axis and has a second distal surface section, which is inclined toward the opening direction, and a second proximal surface section, which is inclined away from the opening direction, and
wherein, with the disconnector open, the second distal surface section is arranged closer toward the first contact element in an axial direction than the second proximal surface section.

12. The electrical high-voltage disconnector as claimed in claim 11, wherein the second distal and second proximal surface sections have a mutually different inclination.

13. The electrical high-voltage disconnector as claimed in claim 1, wherein the first contact element and the second contact element are offset radially relative to one another with respect to an axis of the disconnector.

14. The electrical high-voltage disconnector as claimed in claim 1, wherein the first and second latching elements each comprise a magnet.

15. The electrical high-voltage disconnector as claimed in claim 14, wherein, upon the opening of the disconnector, the adhesion force of the latched connection in the second position region of the first contact element relative to the disconnecting axis is releasable by means of one of the magnets being switched off.

16. The electrical high-voltage disconnector as claimed in claim 1, comprising:
an erosion section arranged at a distal end of the second contact piece, the distal end being directed toward the first contact piece with the disconnector open.

17. A method for opening an electrical high-voltage disconnector, wherein the high-voltage disconnector includes:
a first contact element with a first latching element fixed thereto;
a drive system for moving the first movable contact element in an opening direction along the disconnecting axis relative toward the second contact element to open the disconnector;
a second contact element with a second latching element fixed thereto; and
a restoring system configured for restoring the second contact element counter to the opening direction,
wherein the method comprises:
closing the disconnector such that the first latching element and the second latching element are latched into one another and form a latched connection;
moving the first contact element in the opening direction along a disconnecting axis through a first position region of the first contact element relative to the disconnecting axis;
maintaining an adhesion force of the latched connection upon the movement of the first contact element in the opening direction through the first position region, such that the second contact element is carried along by the first contact element upon the movement of the first contact element in the opening direction;
releasing the holding force in a second position region of the first contact element, the second position region being adjacent to the first position region relative to the disconnecting axis;
restoring the second contact element by the restoring system counter to the opening direction, such that the second contact element is disconnected from the first contact element.

18. The electrical high-voltage disconnector as claimed in claim 2, where the first and second contact elements have respective erosion sections, which are arranged to support an arc which can be formed between them.

19. The electrical high-voltage disconnector as claimed in claim 18, wherein the restoring system comprises a restoring spring.

20. The electrical high-voltage disconnector as claimed in claim 19, wherein, upon the opening of the disconnector, the adhesion force of the latched connection in the second position region of the first contact element relative to the disconnecting axis is releasable due to a force component of the restoring system that acts in the direction of the disconnecting axis exceeds a force component of the adhesion force that acts in the direction of the disconnecting axis.

21. The electrical high-voltage disconnector as claimed in claim 19, comprising:
a gas-tight housing wherein the restoring system has a damping element arranged within an internal volume of the housing.

22. The electrical high-voltage disconnector as claimed in claim 10, wherein the first latching element is embodied as a projection protruding radially toward the second latching element with respect to an axis of the disconnector and has a first distal surface section, which is inclined away from the opening direction, and a first proximal surface section, which is inclined toward the opening direction,
wherein, with the disconnector open, the first distal surface section is arranged closer toward the second contact element in an axial direction than the first proximal surface section,
wherein the second latching element is embodied as a projection protruding radially toward the first latching element with respect to the axis and has a second distal surface section, which is inclined toward the opening direction, and a second proximal surface section, which is inclined away from the opening direction, and
wherein, with the disconnector open, the second distal surface section is arranged closer toward the first contact element in an axial direction than the second proximal surface section.

23. The electrical high-voltage disconnector as claimed in claim 12, wherein the inclination of the second proximal surface section is greater than that of the second distal surface section.

24. The electrical high-voltage disconnector as claimed in claim 13, wherein the first contact element is arranged radially further outward than the second contact element and the first latching element is directed radially inward and the second latching element is directed radially outward.
